(19) United States
(12) Patent Application Publication
(10) Pub. No.: US 2016/0268855 A1
(43) Pub. Date: Sep. 15, 2016

(54) MAGNET-EMBEDDED ROTOR AND METHOD FOR MAKING THE SAME

(71) Applicant: FANUC CORPORATION, Yamanashi (JP)

(72) Inventor: Takeshi Tamaki, Yamanashi (JP)

(73) Assignee: FANUC CORPORATION, Yamanashi (JP)

(21) Appl. No.: 15/064,021

(22) Filed: Mar. 8, 2016

(30) Foreign Application Priority Data
Mar. 12, 2015 (JP) 2015-050015

(51) Int. Cl. H02K 1/27; H02K 1/28; H02K 15/03

(52) U.S. Cl. CPC H02K 1/274; H02K 15/03; H02K 1/28

(57) ABSTRACT

There is provided a rotor which can be created at low cost and in a short period of time without decreasing its strength.

The rotor includes: a plurality of pole magnetic bodies which are disposed so as to sandwich each of a plurality of permanent magnets around a rotation axis in a circumferential direction; a ring-shaped magnetic body which is radially-inwardly placed relative to the permanent magnets and the pole magnetic bodies; an engaging part which is radially-inwardly formed on the pole magnetic body; and an engaged part which is formed on the ring-shaped magnetic body so as to be engaged with the engaging part. The engaging part and the engaged part are engaged with each other via a non-magnetic material part which consists of a non-magnetic material and is placed in a gap between the engaging part and the engaged part.

### BACKGROUND OF THE INVENTION

1. Field of the Invention

The present invention relates to a magnet-embedded rotor and a method for making such rotor.

2. Description of the Related Art

In general, a magnet-embedded rotor has a plurality of fan-shaped pole magnetic bodies and a plurality of permanent magnets alternately attached to each other in a circumferential direction, and has a ring-shaped body located near a rotation axis to secure these pole magnetic bodies and permanent magnets.

Japanese Laid-open Utility Model Application Publication No. 3-97354 discloses a rotor with a ring-shaped body which is formed of a magnetic material. According to Japanese Laid-open Utility Model Application Publication No. 3-97354, between a pole magnetic body and a ring-shaped body is formed a substantially H-shaped punched hole which extends from the pole magnetic body to the ring-shaped body and has a wide part at both of its ends.

Japanese Laid-open Utility Model Application Publication No. 3-97353 discloses a rotor with a ring-shaped body which is formed of a non-magnetic material.

According to Japanese Laid-open Patent Publication No. 4-334937, a tie rod is inserted into a through hole created in a pole magnetic body to fasten a plurality of pole magnetic bodies together.

### SUMMARY OF INVENTION

According to Japanese Laid-open Utility Model Application Publication No. 3-97354, the wide part of a punched hole can inhibit magnetic flux leakage from permanent magnets into the inner periphery of the rotor. However, to further prevent magnetic flux leakage, the punched hole needs to have a wider part. As the size of the wide part of the punched hole is increased, the rotor loses strength, making it difficult to rotate at high speed.

On the other hand, as described in Japanese Laid-open Utility Model Application Publication No. 3-97353, the ring-shaped body composed of a non-magnetic material is less strong than the pole magnetic body that is usually made of iron. Thus, a rotor having the ring-shaped body composed of a non-magnetic material has less strength, making it difficult to rotate the rotor at high speed. Such a rotor is also problematic in that it will require higher cost if the ring-shaped body is made of stainless steel. Japanese Laid-open Utility Model Application Publication No. 3-97353 further poses a problem of the fitting part which requires high-precision machining.

In this regard, the rotor can be made stronger by inserting a tie rod into a through hole, as described in Japanese Laid-open Patent Publication No. 4-334937. However, Japanese Laid-open Patent Publication No. 4-334937 poses a problem of requiring a greater number of parts, resulting in higher cost and in a longer time to assemble a rotor.

The prevent invention, having been designed in view of such circumstances, has objects to provide a rotor which can be created at low cost and in a short period of time without decreasing its strength and to provide a method for making such rotor.

In order to achieve the above-described objects, according to a first aspect, there is provided a rotor including: a plurality of permanent magnets which are placed at equal spaces around a rotation axis in a circumferential direction; a plurality of pole magnetic bodies which are disposed so as to sandwich each of the plurality of permanent magnets around the rotation axis in a circumferential direction; a ring-shaped magnetic body which is radially-inwardly placed relative to the plurality of permanent magnets and the plurality of pole magnetic bodies; an engaging part which is radially-inwardly formed on each of the plurality of pole magnetic bodies; and an engaged part which is formed on the ring-shaped magnetic body so as to be engaged with the engaging part, wherein the engaging part and the engaged part are engaged with each other via a non-magnetic material part which consists of a non-magnetic material and is placed in a gap between the engaging part and the engaged part, thereby securing the plurality of permanent magnets, the plurality of pole magnetic bodies, and the ring-shaped magnetic body to one another.

According to a second aspect, as in the first aspect, the engaging part is a groove and the engaged part is a protrusion.

According to a third aspect, as in the first aspect, the engaging part is a protrusion and the engaged part is a groove.

According to a fourth aspect, as in the second or third aspect, the groove in its cross section includes a wide groove part which is wider than the width of an entry of the groove in the circumferential direction, and the protrusion in its cross section includes a wide protrusion part which is wider than a base end of the protrusion in the circumferential direction.

According to a fifth aspect, as in any one of the first to fourth aspects, the plurality of pole magnetic bodies and the ring-shaped magnetic body are formed partially integrally with each other.

According to a sixth aspect, as in any one of the first to fifth aspects, the non-magnetic material in a melt state is filled in a gap between the engaging part on each of the plurality of magnetic bodies and the engaged part on the ring-shaped magnetic body in an assembled rotor.

According to a seventh aspect, there is provided a motor which includes the rotor of any one of the first to sixth inventions.

According to an eighth aspect, there is provided a method for making a rotor, the method including the steps of: placing a plurality of permanent magnets at equal spaces around a rotation axis in a circumferential direction; disposing a plurality of pole magnetic bodies to have each of the plurality of permanent magnets placed in between around the rotation axis in the circumferential direction; placing a ring-shaped magnetic body radially inwardly relative to the plurality of permanent magnets and the plurality of pole magnetic bodies; placing, into a die, the plurality of permanent magnets, the plurality of pole magnetic bodies, and the ring-shaped magnetic body, with an engaging part and an engaged part being engaged with each other, the engaging part being radially-inwardly formed on each of the plurality of pole magnetic bodies, and the engaged part being formed on the ring-shaped magnetic body so as to be engaged with the engaging part; and filling a non-magnetic body in a molten state between the engaging part and the engaged part, thereby forming a rotor including a non-magnetic material part.

According to a ninth aspect, as in the eighth aspect, the plurality of pole magnetic bodies and the ring-shaped magnetic body are formed partially integrally with each other.

The above objects, features, and advantages as well as other objects, features, and advantage of the present invention will become apparent upon reading detailed description of exemplary embodiments of the present invention as illustrated in the accompanying drawings.

### BRIEF DESCRIPTION OF THE DRAWINGS

FIG. 1 is an end view of a motor according to the present invention.

FIG. 2 is an end view of a rotor according to a first embodiment of the present invention.

FIG. 3 is a partial enlarged view of the rotor illustrated in FIG. 2.

FIG. 4 is an end view of a rotor according to a second embodiment of the present invention.

FIG. 5 is an end view of a first magnetic body part of a rotor according to a third embodiment of the present invention.

FIG. 6 is a partial exploded perspective view of a rotor.

FIG. 7 is a perspective view of a rotor according to the first embodiment of the present invention.

FIG. 8 is a perspective view of a rotor according to the third embodiment of the present invention.

FIG. 9 is a partial broken exploded perspective view illustrating how a rotor of the present invention is manufactured.

### DETAILED DESCRIPTION

Embodiments of the present invention will now be described with reference to the accompanying drawings. Like reference symbols indicate like members throughout the drawings below. For ease of understanding, the scale of each of these drawings may be changed as appropriate.

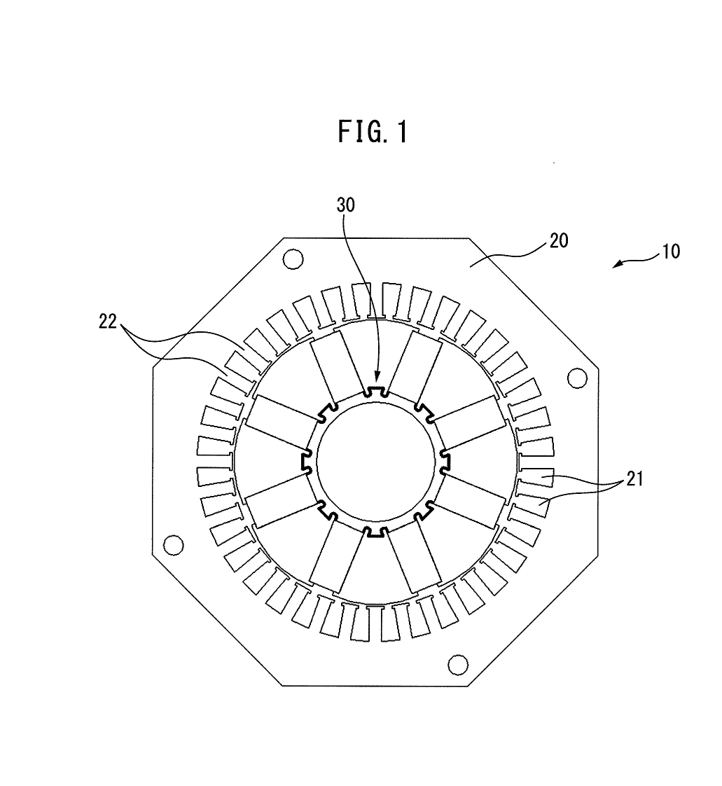

FIG. 1 is an end view of a motor according to the present invention. The motor 10 illustrated in FIG. 1 includes, as major components, a stator 20 and a rotor 30 placed inside the stator 20. The stator 20 includes a stator core in which a plurality of magnetic steel sheets are laminated. On the inner circumferential surface of the stator 20, a plurality of slots 21 are formed at equal spaces. A coil (not illustrated) is wound on each of teeth 22 between adjacent slots 21.

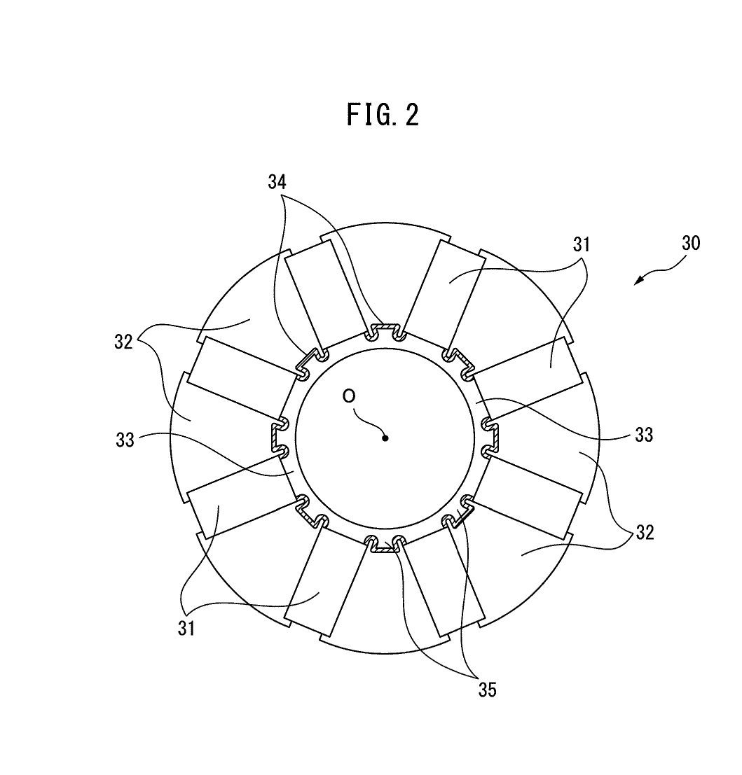

FIG. 2 is an end view of a rotor according to a first embodiment of the present invention. As illustrated in FIGS. 1 and 2, the rotor 30 includes a plurality of, e.g., eight, permanent magnets equally spaced around a rotation axis O in a circumferential direction; and substantially fan-shaped pole magnetic bodies 32 each of which is placed between the permanent magnets 31. The number of permanent magnets 31 corresponds to the number of poles of the motor 10.

As illustrated in FIG. 2, these eight permanent magnets 31 are respectively rectangular in cross-section and are placed so as to radially extend in the rotor 30. In addition, any two adjacent pole magnetic bodies 32 are placed to have one permanent magnet 31 in between.

A ring-shaped magnetic body 33 is placed on the inner side of an end of a permanent magnet 31, the end being radially-inwardly positioned in the rotor 30. Pole magnetic bodies 32 and the ring-shaped magnetic body 33 are formed of magnetic materials, such as iron or magnetic steel sheets. The material used for forming pole magnetic bodies 32 may be different from the one for the ring-shaped magnetic body 33 as far as both pole magnetic bodies 32 and the ring-shaped magnetic body 33 are formed of magnetic materials.

In addition, as illustrated in FIG. 2, engaging parts 34 are formed on the inner side of ends of the plurality of pole magnetic bodies 32, the ends being radially-inwardly positioned in the rotor 30. Engaged parts 35 are formed to be engaged with engaging parts 34 on the outer circumferential surface of the ring-shaped magnetic body 33, the outer circumferential surface being radially-outwardly positioned in the rotor 30. In the embodiment illustrated in FIG. 2, engaging parts 34 are grooves extending along the rotation axis O and engaged parts 35 are radially-inwardly projecting protrusions.

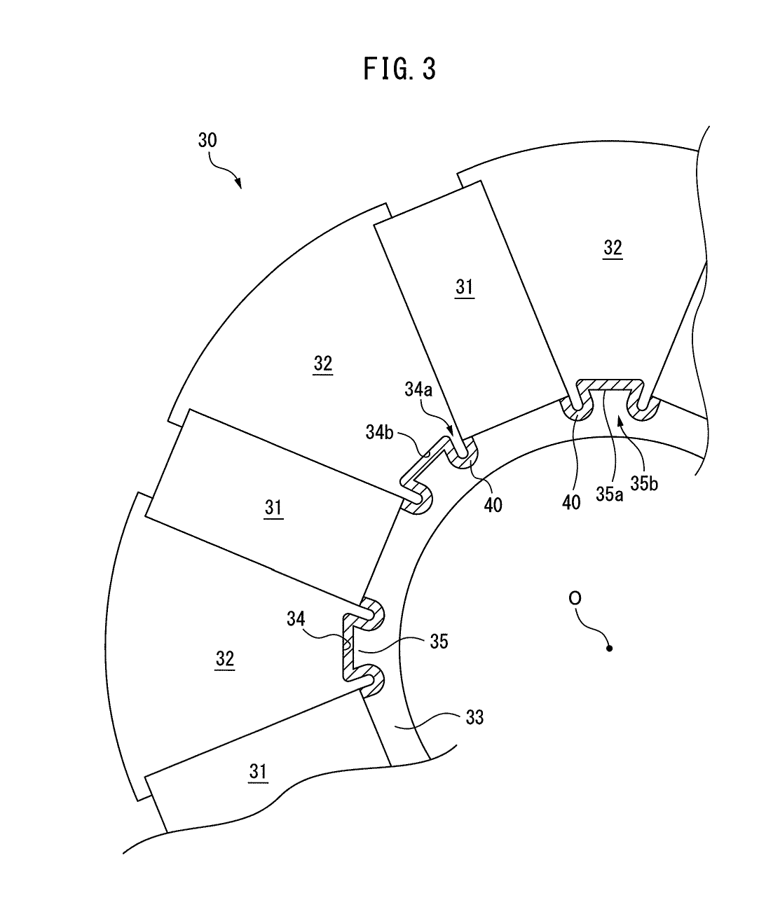

FIG. 3 is a partial enlarged view of the rotor illustrated in FIG. 2. As illustrated in FIG. 3, an engaging part 34 perpendicular to the rotation axis O forms an inverted trapezoid in cross-section whereas an engaged part 35 perpendicular to the rotation axis O forms a trapezoid in cross-section matching the inverted one. Accordingly, on a circumferential direction in the rotor 30, an engaging part 34, which forms a groove, has its bottom part 34b being wider than its entry part 34a. Likewise, on a circumferential direction in the rotor 30, an engaged part 35, which forms a protrusion, has its distal end 35a being wider than its base end 35b. Owing to this configuration, the present invention allows the pole magnetic bodies 32 and the ring-shaped magnetic body 33 to be firmly secured by engaging the engaging part 34 and the engaged part 35 with each other. The fan shape of a pole magnetic body 32 also causes a permanent magnet 31 to be firmly secured between two adjacent pole magnetic bodies 32 by engaging the engaging part 34 and the engaged part 35 with each other.

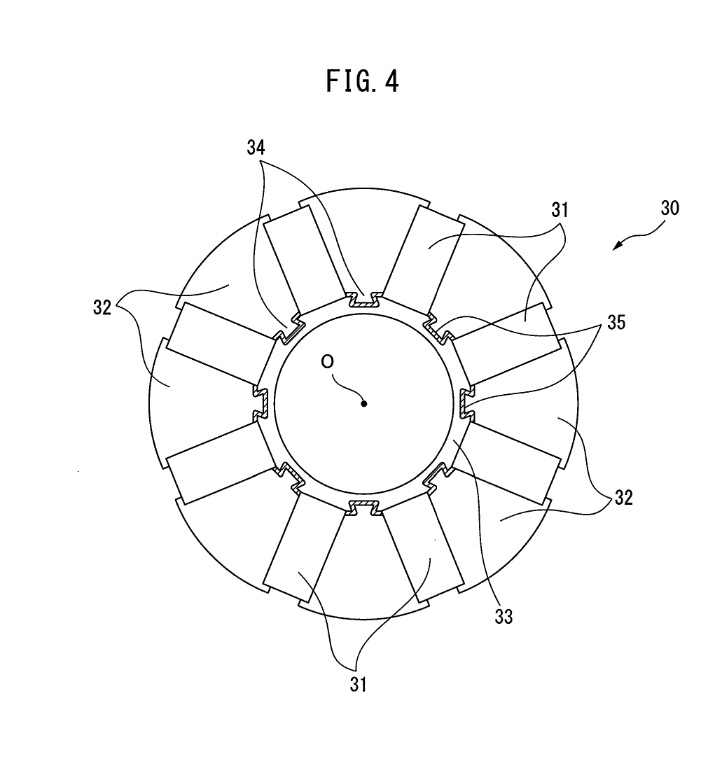

FIG. 4 is an end view of a rotor according to a second embodiment of the present invention. In the embodiment illustrated in FIG. 4, an engaging part 34 on a pole magnetic body 32 forms a protrusion while an engaged part 35 on a ring-shaped magnetic body 33 forms a groove. Hence, the engaging part 34 and the engaged part 35 depicted in FIG. 4 are different in shape from the engaging part 34 and the engaged part 35 depicted in FIG. 2. However, in spite of such difference, it will be seen that the pole magnetic bodies 32 and the ring-shaped magnetic body 33 can still be firmly secured. Note that the engaging part 34 and the engaged part 35 are not necessarily be in a trapezoid shape; the engaging part 34 and the engaged part 35 may be in any shape that ensures firm engagement with each other.

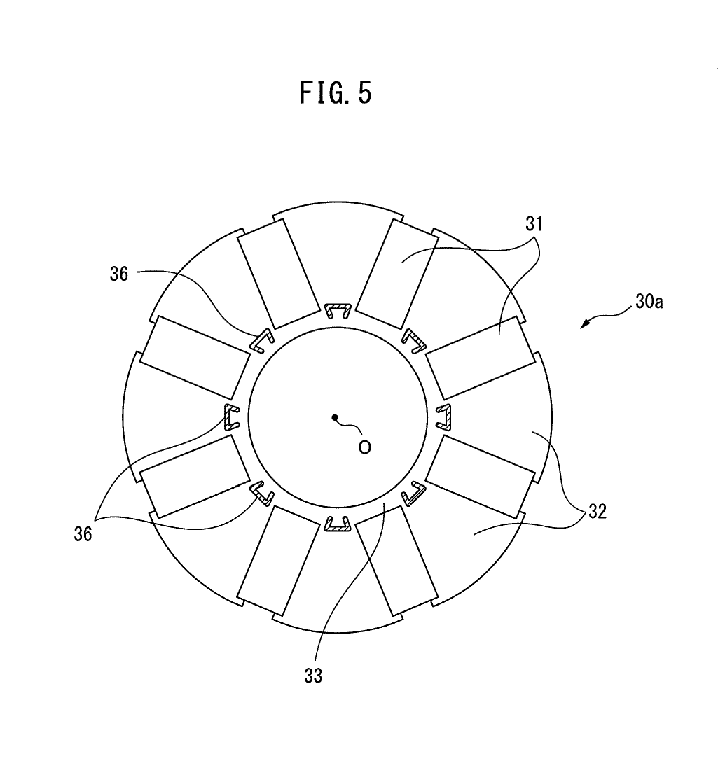

FIG. 5 is an end view of a first magnetic body part of a rotor according to a third embodiment of the present invention. FIG. 5 illustrates a first magnetic body part 30a, which is a portion of the rotor 30. In the first magnetic body part 30a illustrated in FIG. 5, a slit 36 is formed between a ring-shaped magnetic body 33 and each of a plurality of pole magnetic bodies 32. As can be seen from FIG. 5, each slit 36 is substantially U-shaped with its base facing the pole magnetic body 32. In other words, the base of a slit 36 is adjacent to the radially-inwardly facing end of a substantially fan-shaped pole magnetic body 32.

However, as can be seen from FIG. 5, the formed slit 36 is not all along the radially-inwardly facing end of a pole magnetic body 32. Both ends of the base of a slit 36 are away from a pole magnetic body 32 by a predetermined distance. Accordingly, in the first magnetic body part 30a illustrated in FIG. 5, the plurality of pole magnetic bodies 32 and the ring-shaped magnetic body 33 are at least partially integrated. In other words, it is possible to create a single member where pole magnetic bodies 32 are partially connected to the ring-shaped magnetic body 33 by forming a plurality of slits 36 in the first magnetic body part 30a.

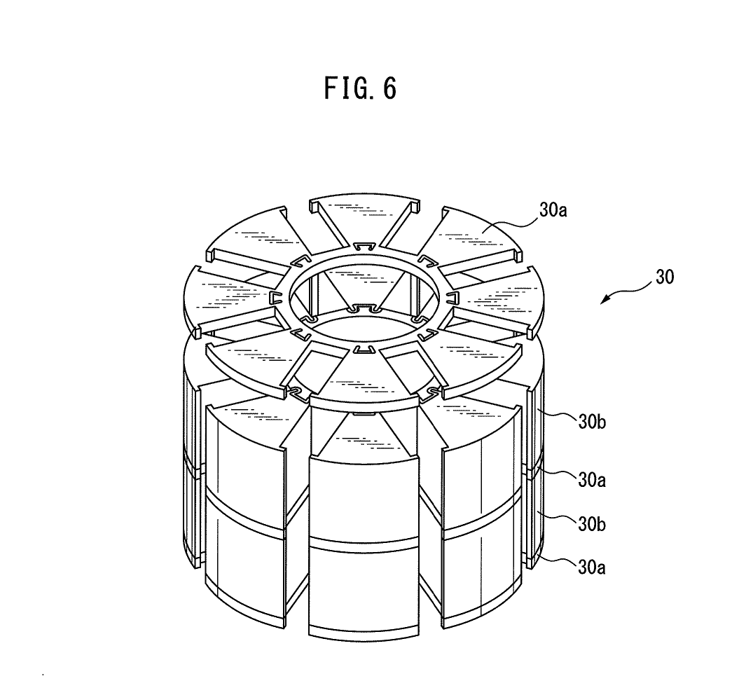

FIG. 6 is a partial exploded perspective view of the rotor. Since the rotor 30 illustrated in FIG. 6 is midway through its assembly, permanent magnets 31 are not depicted in FIG. 6. FIG. 6 illustrates a first magnetic body part 30a, which includes pole magnetic bodies 32 and a ring-shaped magnetic body 33 as depicted in FIG. 5; and a second magnetic body 30b, which includes a plurality of magnetic steel sheets that are stacked in the axial direction and jointed each other through caulking. As illustrated in FIG. 6, the second magnetic body part 30b has a height along the axis that is much greater than that of the first magnetic body part 30a. FIG. 6 also represents that the first magnetic body parts 30a and the second magnetic body parts 30b are stacked alternately.

Magnetic steel sheets for the second magnetic body part 30b are structured in almost the same way as illustrated in FIGS. 2 and 4. In other words, in the second magnetic body part 30b, pole magnetic bodies 32 are separated from the ring-shaped magnetic body 33. On the other hand, in the first magnetic body part 30a, pole magnetic bodies 32 and the ring-shaped magnetic body 33 are partially connected to each other, as described above with reference to FIG. 5. In other words, the first magnetic body part 30a itself is a single member.

Thus, using the first magnetic body part 30a in combination with the second magnetic body part 30b, as illustrated in FIG. 6, can achieve fewer number of components needed for creating a rotor 30 and fewer man-hours for assembling it. Note that the rotor 30 can also be created by stacking a plurality of first magnetic body parts 30a.

With reference to FIG. 3 again, a non-magnetic material part 40 is disposed between an engaging part 34 on a pole magnetic body 32 and an engaged part 35 on the ring-shaped magnetic body 33. In the embodiment illustrated in FIG. 3, the non-magnetic material part 40 is placed to fill all of the gaps between the engaging part 34 and the engaged part 35. The non-magnetic material part 40 is made of a non-magnetic material, such as resin, aluminum, magnesium, or copper. Note that FIG. 4 also assumes that a non-magnetic material part 40 is formed between the engaging part 34 and the engaged part 35. In addition, note that FIG. 5 assumes that a non-magnetic material part 40 is disposed in slits 36.

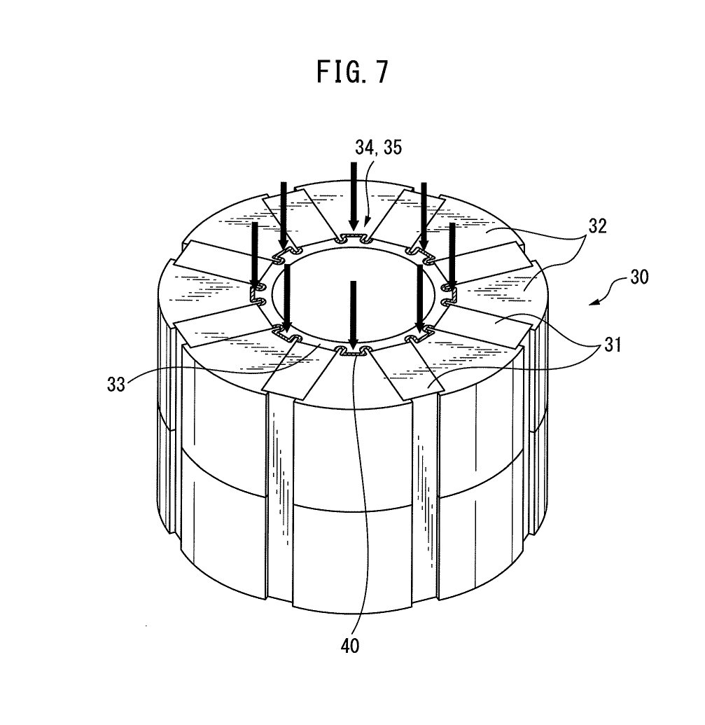

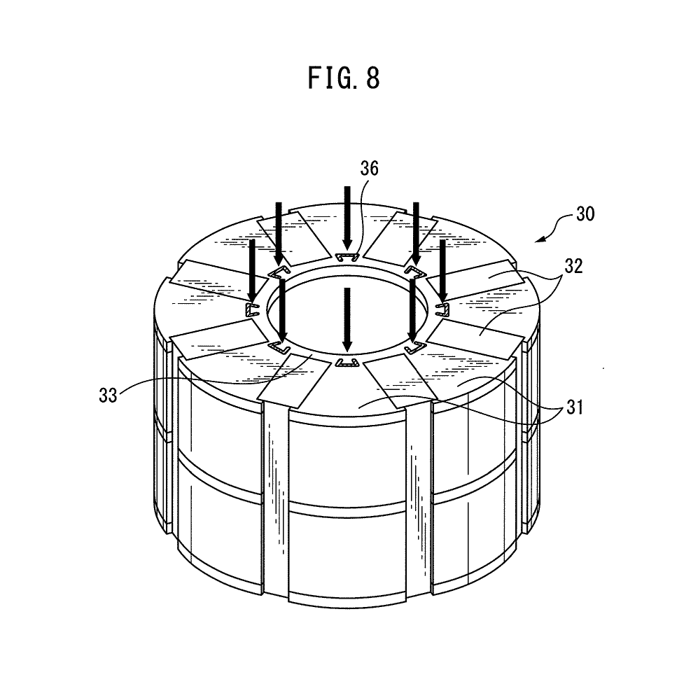

FIG. 7 is a perspective view of a rotor according to the first embodiment of the present invention. After the rotor 30 is assembled, a non-magnetic material in a molten state is filled into a gap between an engaging part 34 and an engaged part 35 to create a non-magnetic material part 40, as indicated by arrows in FIG. 7. FIG. 8 is a perspective view of a rotor according to the third embodiment of the present invention. After the rotor 30 is assembled, a non-magnetic material in a molten state is poured and filled into slits 36 to create non-magnetic material parts 40, as indicated by arrows in FIG. 8. Thus, non-magnetic material parts 40 can be created very easily according to the present invention.

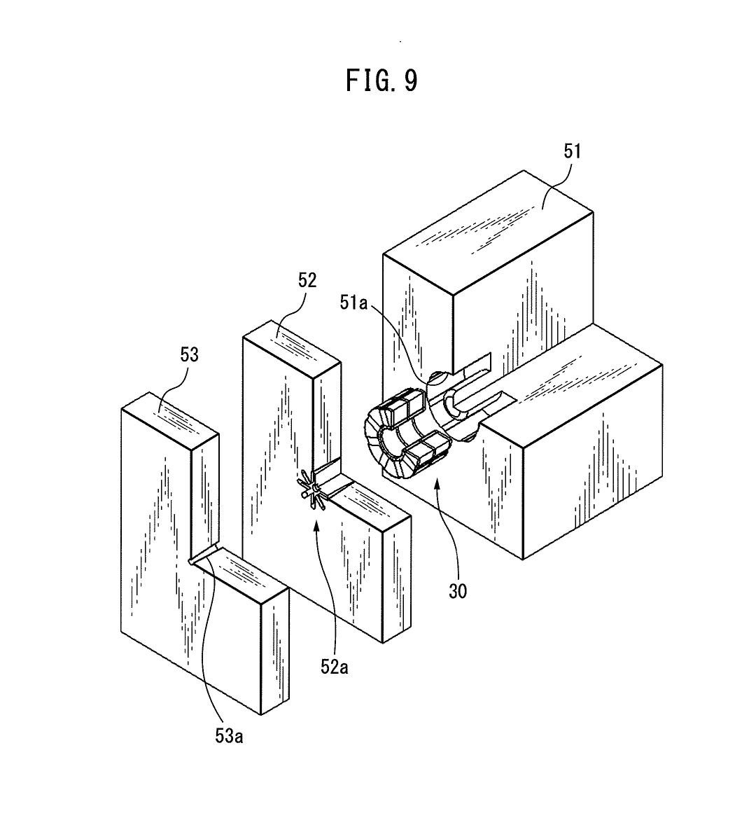

FIG. 9 is a partial broken exploded perspective view illustrating how a rotor of the present invention is manufactured. FIG. 9 depicts a movable side die plate 51, a fixed side die plate 53, and a plate 52 disposed between the movable side die plate 51 and the fixed side die plate 53. The fixed side die plate 53 and the plate 52 are used in an integrated manner. The movable side die plate 51 has a ring-shaped insertion hole 51a formed therein into which the rotor 30 will be inserted in the axial direction. When the rotor 30 is inserted into the insertion hole 51a, the top end of the rotor 30 is flush with the end face of the insertion hole 51a, so that the rotor 30 is prevented from rotating in a circumferential direction. It is assumed here that permanent magnets 31 have been assembled into the rotor 30, which is going to be inserted into the insertion hole 51a.

A sprue 53a in the form of a through hole is formed in the fixed side die plate 53 coaxially with the rotor 30. The sprue 53a is well smaller than the rotor 30. In the plate 52 adjacent to the fixed side die plate 53, there are a plurality of, e.g., eight, runners 52a, which radially-outwardly extend from the central axis of the rotor 30 as well as running along the axis toward the rotor 30. Runners 52a can also be described as branch pathways 52a. Each of the runners 52a terminates at the other end of the plate 52 adjacent to the movable side die plate 51. At the other end of the plate 52, each of the runners 52a is situated in a position corresponding to a gap between an engaging part 34 and an engaged part 35 or to a slit 36 of the rotor 30.

The rotor 30 is inserted into the insertion hole 51a in the movable side die plate 51, and then the plate 52 and the fixed side die plate 53, which are used integrally together, abut with the movable side die plate 51. Consequently, the whole rotor 30 is housed between the movable side die plate 51 and the plate 52. Then, a non-magnetic material, such as resin, aluminum, magnesium, or copper, is supplied into the sprue 53a in the fixed side die plate 51 when the material is in a molten state. Thus, the non-magnetic material is allowed to run through the sprue 53a and through each of the runners 52a to flow into a gap between an engaging part 34 and an engaged part 35 or into slits 36 in the rotor 30 (refer to FIGS. 7 and 8).

When the movable side die plate 51, the plate 52, and the fixed side die plate 53 are left or forced to be cooled, the non-magnetic material becomes cured to form non-magnetic material parts 40. Thus, the rotor 30 including non-magnetic material parts 40 can be created very easily according to the present invention.

The present invention allows a non-magnetic material to be filled evenly in the gap between an engaging part 34 and an engaged part 35 or in slits 36, by filling such non-magnetic material in a molten state. This ensures that the non-magnetic material is filled in tiny irregular shapes, if any, between an engaging part 34 and an engaged part 35. Accordingly, the present invention eliminates the need for creating engaging and engaged parts 34 and 35 with high precision. It will thus be understood that engaging and engaged parts 34 and 35 can be easily created.

The present invention also eliminates the need for making a through hole in a pole magnetic body 32 and/or preparing a tie rod, and thus reduces components and man-hours needed for creating the rotor 30 to make it possible to produce the rotor 30 in a short period of time. It is also made possible to create the rotor 30 at low cost because both the pole magnetic bodies 32 and the ring-shaped magnetic body 33 are formed of magnetic materials.

### Effects of the Invention

According to a first aspect, a rotor having higher strength can be created at low cost because a ring-shaped magnetic body is made of a magnetic material such as iron. In addition, magnetic flux leakage can be blocked by a non-magnetic material part disposed between a pole magnetic body and the ring-shaped magnetic body. Furthermore, the need for making a through hole in a pole magnetic body and/or preparing a tie rod is eliminated, and thus the number of components and man-hours needed for creating the rotor are reduced, and therefore it possible to produce the rotor in a short period of time.

According to second and third aspects, an engaging part and an engaged part can be easily created.

According to a fourth aspect, a pole magnetic body and a ring-shaped magnetic body can be securely connected to each other.

According to a fifth aspect, it is possible to improve workability and reduce cost while further reducing the number of components.

According to a sixth aspect, it is possible to securely connect among a pole magnetic body, a non-magnetic material part, and a ring-shaped magnetic body with no empty space in spite of any tiny irregular shape existing between engaging and engaged parts because a non-magnetic material fills up irregular shapes. Consequently, the need for creating the engaging and engaged parts with high precision can be eliminated.

According to a seventh aspect, a motor can be created at low cost and in a short period of time.

According to an eighth aspect, a rotor having higher strength can be created at low cost because a ring-shaped magnetic body is made of a magnetic material such as iron. In addition, magnetic flux leakage can be blocked by a non-magnetic material part disposed between a pole magnetic body and the ring-shaped magnetic body. Furthermore, the need for making a through hole in a pole magnetic body and/or preparing a tie rod is eliminated, and thus the number of components and man-hours needed for creating the rotor are reduced to make it possible to produce the rotor in a short period of time. In addition, it is possible to securely connect among a pole magnetic body, a non-magnetic material part, and a ring-shaped magnetic body with no empty space in spite of any tiny irregular shape existing between engaging and engaged parts because a non-magnetic material fills up irregular shapes. Furthermore, the need for creating the engaging and engaged parts with high precision can be eliminated.

According to a ninth aspect, it is possible to improve workability and reduce cost while further reducing the number of components.

While the present invention has been described with typical embodiments, it will be understood by those skill in the art that the above-described changes and various other changes, omissions, and additions can be made without departing from the scope of the present invention.

1. A rotor comprising:
a plurality of permanent magnets which are placed at equal spaces around a rotation axis in a circumferential direction;
a plurality of pole magnetic bodies which are disposed so as to sandwich each of the plurality of permanent magnets around the rotation axis in a circumferential direction;
a ring-shaped magnetic body which is radially-inwardly placed relative to the plurality of permanent magnets and the plurality of pole magnetic bodies;
an engaging part which is radially-inwardly formed on each of the plurality of pole magnetic bodies; and
an engaged part which is formed on the ring-shaped magnetic body so as to be engaged with the engaging part,
wherein the engaging part and the engaged part are engaged with each other via a non-magnetic material part which consists of a non-magnetic material and is placed in a gap between the engaging part and the engaged part, thereby securing the plurality of permanent magnets, the plurality of pole magnetic bodies, and the ring-shaped magnetic body to one another.

2. The rotor according to claim 1, wherein the engaging part is a groove and the engaged part is a protrusion.

3. The rotor according to claim 1, wherein the engaging part is a protrusion and the engaged part is a groove.

4. The rotor according to claim 2, wherein the groove in its cross section comprises a wide groove part which is wider than the width of an entry of the groove in the circumferential direction, and wherein the protrusion in its cross section comprises a wide protrusion part which is wider than a base end of the protrusion in the circumferential direction.

5. The rotor according to claim 1, wherein the plurality of pole magnetic bodies and the ring-shaped magnetic body are formed partially integrally with each other.

6. The rotor according to claim 1, wherein the non-magnetic material in a molten state is filled in a gap between the engaging part on each of the plurality of magnetic bodies and the engaged part on the ring-shaped magnetic body in an assembled rotor.

7. A motor comprising the rotor according to claim 1.

8. A method for making a rotor, the method comprising steps of:
placing a plurality of permanent magnets at equal spaces around a rotation axis in a circumferential direction;
disposing a plurality of pole magnetic bodies to have each of the plurality of permanent magnets placed in between around the rotation axis in the circumferential direction;
placing a ring-shaped magnetic body radially inwardly relative to the plurality of permanent magnets and the plurality of pole magnetic bodies;
placing, into a die, the plurality of permanent magnets, the plurality of pole magnetic bodies, and the ring-shaped magnetic body, with an engaging part and an engaged part being engaged with each other, the engaging part being radially-inwardly formed on each of the plurality of pole magnetic bodies, and the engaged part being formed on the ring-shaped magnetic body so as to be engaged with the engaging part; and
filling a non-magnetic body in a molten state between the engaging part and the engaged part, thereby forming a rotor comprising a non-magnetic material part.

9. The method for making a rotor according to claim 8, wherein the plurality of pole magnetic bodies and the ring-shaped magnetic body are formed partially integrally with each other.
